(19) United States
(12) Patent Application Publication
(10) Pub. No.: US 2004/0239291 A1
(43) Pub. Date: Dec. 2, 2004

(54) Identifier for batterry, batterry and battery pack

(76) Inventor: Kouji Watanabe, Fukushima (JP)

Correspondence Address: William E. Vaughan, Bell, Boyd & Lloyd LLC, P.O. Box 1135, Chicago, IL, 60690, US

(21) Appl. No.: 10/839,362

(22) Filed: May 5, 2004

(30) Foreign Application Priority Data
May 6, 2003 (JP) P2003-128387

(51) Int. Cl. F21V 7/04

(52) U.S. Cl. 320/106

(57) ABSTRACT

A battery pack and a battery proofed against counterfeiting is provided. The outer surface of the exterior material of the battery and the outer surface of the battery pack are each provided with a light emitting material which, when irradiated with invisible light, emits visible light.

### CROSS REFERENCES TO RELATED APPLICATIONS

This application claims priority to Japanese Patent Application No. 2003-128387, filed in Japan on May 6, 2003, the disclosure of which is incorporated by reference herein.

### BACKGROUND OF THE INVENTION

The present invention generally relates to an identifier for a battery, a battery and a battery pack. More specifically, the present invention relates to an identifier for a battery that can be visually recognized on illuminating invisible light to the battery, a battery and a battery pack identified by the identifier.

The battery is typically classified into a primary battery, such as manganese dry battery, and a secondary battery, such as a lithium ion secondary battery. Of these, the lithium ion secondary battery is lightweight and has a high energy, so that it is used as a power supply for a portable electronic device, such as a mobile phone. If used as a power supply for the electronic device, the lithium ion secondary battery is used as a battery pack which is connected to a circuit substrate provided with a connector terminal connected to an external terminal, as an example, and which is accommodated within a battery case along with the circuit substrate.

There is currently an active demand for such battery and a battery pack which are superior as a general-purpose power supply for the electronic device as described above. Consequently, there is now an increasing risk for counterfeiting, so that, with the battery and the battery pack, it has become necessary for the battery and the battery pack to be distinguishable from counterfeited products.

Among the methods for discriminating the battery and the battery pack, there are a method for recognizing a picture by a camera, and a method for optically detecting a bar code. The method for picture recognition resides in imaging a battery pack with, for example, a camera and analyzing this picture for discrimination. The method for optically detecting a bar code resides in reading out a bar code provided on the outer surface of the battery pack by a bar code scanner for discrimination. There is also a method for providing a discrimination symbol, such as a production lot number, on an electrode plate housed within the battery pack. See, for example, Japanese Patent Application Laid-Open No. H10-64525.

However, with the above-described picture recognition method, if liquid leakage, for example, has occurred in the battery pack during recovery, the outer surface of the battery case is soiled and, as a result of this soil, it becomes difficult to discriminate the picture correctly. If the battery pack is not as yet to be recovered, but the inner portion of the battery pack has been counterfeited, it is difficult with picture analysis with a camera to recognize the inner portions or details. Moreover, with the picture recognizing method, the picture imaging device used is complex and expensive, and hence is poor in operational efficiency. Hence, the picture recognizing method does not suit the discrimination of mass-produced battery packs.

In the bar code detection method, in which the bar code is read out with a bar code scanner, the bar code scanner needs to be contacted with or brought to a proximate position to the bar code, such that difficulties are encountered in achieving full automation of the detection method. Additionally, even with the bar code detection method, as with the aforementioned picture recognition method, correct detection is difficult if the outer surface of the battery case is stained. Moreover, detection is hardly possible in case the interior of the battery pack is counterfeited.

For a case where the interior of the battery pack is counterfeited, there is a method of discriminating the counterfeiting by providing a check circuit on a circuit substrate. However, if such method is used, the cost of the battery pack is extremely expensive, thus lowering the mass producibility and practical utility.

### SUMMARY OF THE INVENTION

The present invention generally relates to an identifier for a battery, a battery and a battery pack. More specifically, the present invention relates to an identifier for a battery that can be visually recognized on illuminating invisible light to the battery, a battery and a battery pack identified by the identifier.

In an embodiment, the present invention provides a battery identifier provided to a battery or a battery pack and which permits readily determining whether or not a battery or a battery pack is a genuine product, and a battery or a battery pack provided with this battery identifier.

In this regard, the present invention in an embodiment provides a battery identifier provided on a battery or a battery pack and including a light emitting material which is colorless against visible light and which, when illuminated by the invisible light, emits the visible light.

The battery identifier of the present invention, including the light emitting material which, when illuminated by the invisible light, emits the visible light, is provided on the outer surface of the battery or on the outer surface of the battery pack according to an embodiment. For example, the battery identifier can be irradiated with invisible light to help identify the battery or the battery pack.

The present invention also provides a battery that includes a battery element having a cathode and an anode, an exterior material for accommodating the battery element, and a battery identifier provided on an outer surface of the exterior material pursuant to an embodiment. The battery identifier includes a light emitting material which is colorless against visible light and which, when illuminated by the invisible light, emits the visible light.

The battery identifier provided on the outer surface of the exterior material of the battery includes a light emitting material which, when illuminated by the invisible light, emits the visible light. Hence, the battery can be identified readily by being illuminated with the invisible light.

The present invention also provides a battery pack that includes a battery provided with a cathode and an anode and operating as a power generating element, a battery case for accommodating the battery therein, and a battery identifier provided to the outer surface of the battery case pursuant to an embodiment. The battery identifier is colorless against visible light and emits the visible light when illuminated by the invisible light.

The battery identifier provided on the outer surface of the exterior material of the battery case of the battery pack includes the light emitting material which, when illuminated by the invisible light, emits the visible light. Hence, the battery pack can be identified readily by being illuminated with the invisible light.

With the present invention, the battery identifier is colorless against the visible light, and emits visible light when irradiated with the visible light, so that, by providing this battery identifier to the battery and to the battery pack, it is possible to check the battery and the battery pack as to authentication and to identify the battery and the battery pack by illuminating the invisible light on the battery identifier.

Additional features and advantages of the present invention are described in, and will be apparent from, the following Detailed Description of the Invention and the figures.

### BRIEF DESCRIPTION OF THE FIGURES

FIG. 1 is a perspective view of a battery pack according to an embodiment of the present invention.

FIG. 2 is an exploded perspective view of the battery pack according to an embodiment of the present invention.

FIG. 3 is a cross-sectional view of a polymer battery according to an embodiment of the present invention.

FIG. 4 is a cross-sectional view of an identifier label according to an embodiment of the present invention.

FIG. 5 is a plan view showing changes in the identifier label illuminated by invisible light according to an embodiment of the present invention.

FIG. 6 is a perspective view showing the state in which the identifier label is provided on the outer surface of an exterior material of a polymer battery according to an embodiment of the present invention.

### DETAILED DESCRIPTION OF THE INVENTION

The present invention generally relates to an identifier for a battery, a battery and a battery pack. More specifically, the present invention relates to an identifier for a battery that can be visually recognized on illuminating invisible light to the battery, a battery and a battery pack identified by the identifier.

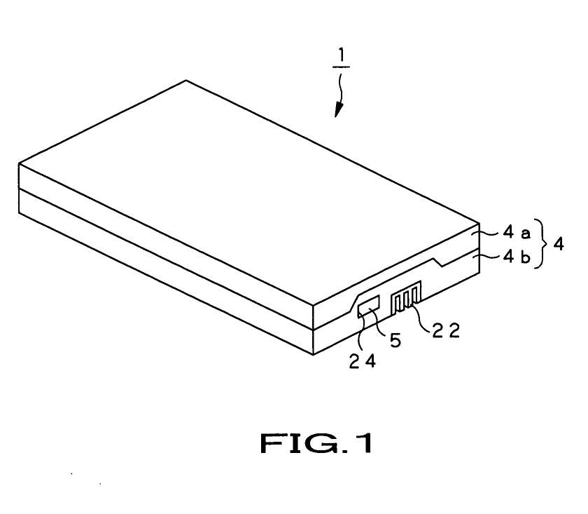

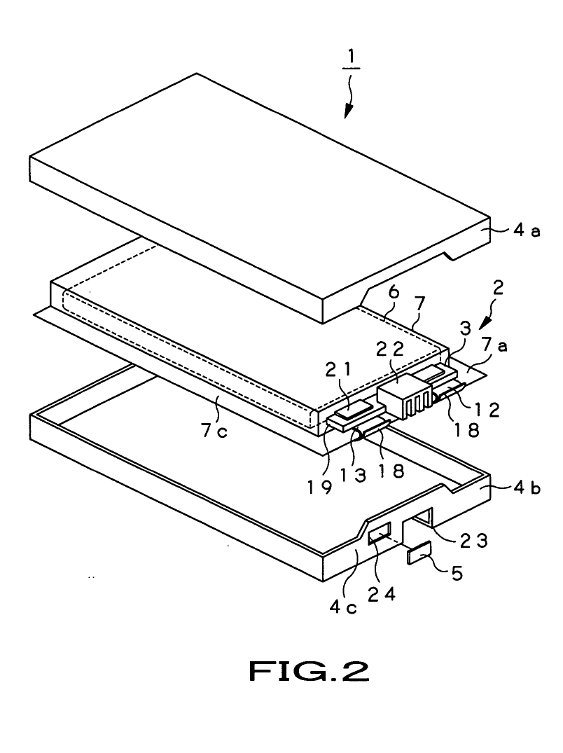

Referring to the drawings, a battery pack, embodying the present invention, is explained in detail. A battery pack 1, shown in FIGS. 1 and 2, includes a polymer battery 2, for supplying the power to, for example, an electronic device, a circuit substrate 3, electrically connected to the polymer battery 2, a battery case 4 in which to accommodate the polymer battery 2 and the circuit substrate 3, and an identifier label 5 for identifying the battery pack 1.

The polymer battery 2 is, for example, a non-aqueous electrolyte secondary battery, such as a lithium ion secondary battery, and is made up by a battery element 6, as a power generating element, and an exterior material 7, in which to accommodate the battery element 6.

The battery element 6 is made up by an elongated cathode 8, an elongated anode 9, a solid electrolyte 10, formed on both sides of each of the cathode 8 and the anode 9, and a separator 11 interposed between the cathode 8 carrying the solid electrolyte 10 and the anode 9 carrying the solid electrolyte 10. The battery element 6 is formed by wrapping the cathode 8 carrying the solid electrolyte 10 and the anode 9 carrying the solid electrolyte 10, with the separator 11 in-between. A cathode terminal 12 is connected to the cathode 8, and an anode terminal 13 is connected to the anode 9, with the cathode terminal 12 and the anode terminal 13 protruding from one end face of the battery element 6. Thus, the polymer battery 2 is of such a structure in which the battery element 6 is encapsulated within the exterior material 7, with the cathode terminal 12 and the anode terminal 13 protruding via a bonding surface 7a of the exterior material 7 from one end face of the battery element 6.

The cathode 8 includes a layer of a cathode active material 15 on each major surface of a cathode collector 14. The cathode collector 14 includes foliate aluminum, expanded aluminum, or the like. The layer of a cathode active material 15 is formed by applying a cathode mixture containing a cathode active material and a binder on each major surface of the cathode collector 14, drying the resulting product and pressuring the resulting dried product.

As the cathode active material, lithium composite oxides, mainly composed of LiₓMO₂, where M denotes at least one transition metal from among Co, Ni, Mn, Fe, Al, V and Ti, with 0.5≦x≦1.10, can be used or other suitable materials in an embodiment.

As the binder, polyvinilydene fluoride, polyvinylpyridine, polytetrafluoroethylene or the like, used as a cathode mixture of the non-aqueous electrolyte battery, for example, can be used. The cathode mixture can be admixed with, for example, a carbonaceous material, as an electrically conductive material, or with other known and suitable types of additives.

To the cathode 8, there is electrically connected a cathode terminal 12 in the form of a strip of an electrically conductive metal, such as aluminum. This cathode terminal 12 is bonded, such as by resistance welding or ultrasonic welding, to a bared portion of the cathode collector 14, not shown, provided to, for example, a longitudinal end, such as an inner rim end, of the cathode 8. The bared portion of the cathode collector means the portion of the cathode collector 14 which is slightly larger than the width of the cathode terminal 12 and which is not provided with the layer of a cathode active material 15. The cathode terminal 12 is provided for extending from the width-wise direction of the cathode 8.

The anode 9 includes a layer of an anode active material 17 formed on each major surface of an anode collector 16. The anode collector 16 is formed of, for example, foliate nickel, expanded nickel or the like. The anode active material 17 is formed by applying an anode mixture, containing an anode active material and a binder, on each major surface of the anode collector 16, drying the resulting product and pressuring the resulting dried product.

The anode active material can, for example, be a carbonaceous material, having a potential not larger than about 2V with respect to lithium and which is capable of doping/undoping lithium, a low crystalline carbon material, obtained on sintering at a lower temperature of about 2000° C. or lower, a high crystalline carbon material, such as artificial graphite, obtained on sintering a readily crystalizable starting material at a higher temperature in the vicinity of about 3000° C. or the like.

As the anode active material, an element that can be reacted with lithium, a compound of this element, a high molecular material, such as polyacetylene or polypyrrole, an oxide capable of doping/undoping lithium, a nitride obtained on substituting nitrogen for the carbon of the oxide and the like, can be used in addition to the aforementioned carbonaceous material.

The binder can be enumerated by, for example, polyvinylidene fluoride, polyvinyl pyridine, polytetrafluoroethylene or the like that can be used for an anode mixture of the non-aqueous electrolyte battery.

To the anode 9 is electrically connected the anode terminal 13, which is a strip of an electrically conductive metal, such as nickel. This anode terminal 13 is connected, such as by resistance welding or ultrasonic welding, to a bared portion of an anode collector, provided to one end (for example, an outer rim side end) along the longitudinal direction of the anode 9. The bared portion of the anode collector means the portion of the anode collector 16 which is slightly larger than the width of the anode terminal 13 and which is not provided with the layer of the anode active material 17. The anode terminal 13 is provided for extending from the width-wise direction of the anode 9 in the same direction as the cathode terminal 12.

The solid electrolyte 10 is a gelled electrolyte, obtained on adding a non-aqueous liquid electrolyte as a plasticizer to a high molecular matrix, or a high molecular solid electrolyte obtained on dissolving an electrolyte salt in a high molecular material. The solid electrolyte 10 can be prepared by coating both major surfaces of the cathode 8 and the anode 9 with a solution containing a high molecular compound and an electrolyte salt and by solidifying the resulting product.

The separator 11 is used for separating the cathode 8 and the anode 9 from each other. The separator is any suitable well-known component routinely used as an insulating porous film for this sort of the non-aqueous electrolyte battery, for example, a high-molecular film of polypropylene, polyethylene and the like.

The exterior material 7, which encapsulates the aforementioned battery element 6, is formed, for example, of a laminate film obtained on layering and bonding together a resin film and a metal foil. Of these, the resin film is formed of a material exhibiting bonding properties for the, cathode terminal 12 and the anode terminal 13 and also exhibiting air-tightness, for example, an organic resin material, such as polyethylene, polypropylene, modified polyethylene, modified polypropylene, copolymers thereof, or polyolefin resins. On the other hand, the metal foil is formed of, for example, aluminum, stainless steel, nickel, iron and the like.

The exterior material 7 encapsulates the battery element 6 and has an outer rim portion extending along the outer shape of the battery element 6 bonded together by heat fusion to encapsulate the battery element 6. At this time, the exterior material 7 has the resin film as the inner surface and the cathode terminal 12 and the anode terminal 13 are pulled outwards from the bonding surface 7a, registering with the end face of a coiled body of the battery element 6, from among bonding surfaces 7a to 7c, bonded together by heat fusion.

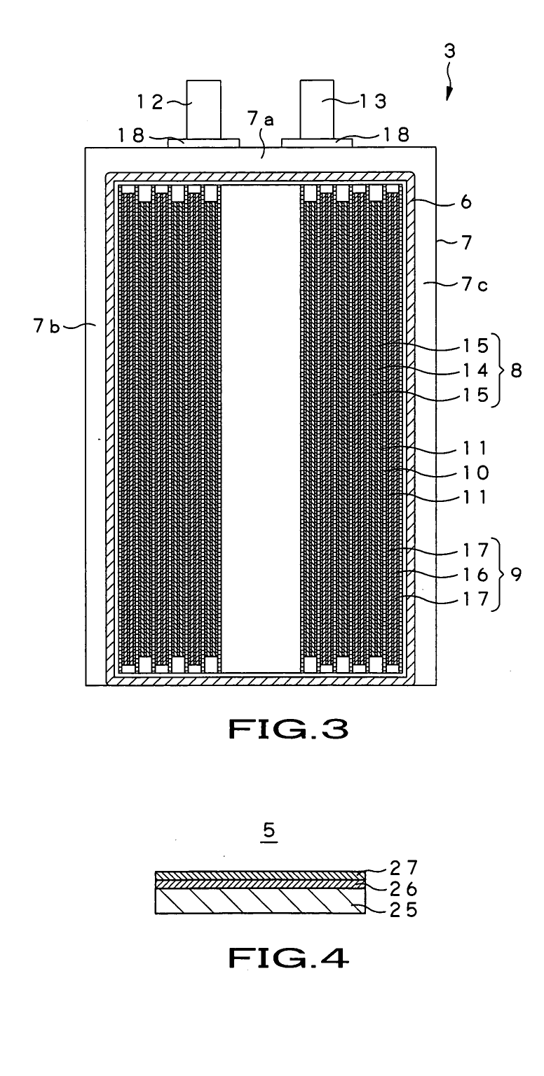

On the inner side of the exterior material 7, bonded as described above, there is provided a resin piece 18, melted by heat fusion in the contact portions between the cathode terminal 12 and the anode terminal 13 on one hand and the exterior material 7 on the other hand, in order to improve the tight bonding between the cathode terminal 12 and the anode terminal 13 on one hand and the exterior material 7 on the other hand. This resin piece 18 can be formed of a material exhibiting bonding properties with respect to the cathode terminal 12 and the anode terminal 13, for example, polyolefin resin, such as polyethylene or polypropylene, and copolymers thereof. In this manner, the polymer battery 2, shown in FIG. 3, is formed.

The circuit substrate 3 has a circuit component 21 mounted on a mounting surface 20 of a substantially rectangular substrate 19, as shown in FIG. 2. This circuit substrate 3 is arranged on the bonding surface 7a of the exterior material 7 from which have been drawn out the cathode terminal 12 and the anode terminal 13 of the polymer battery 2.

A substrate 19 is sized so as to be just large enough to be arranged on the bonding surface 7a of the exterior material 7 of the battery pack 1, and includes, for example, a control circuit (not shown) for protection against overcharging or overdischarging, and a communication circuit (not shown) for communicating with the electronic equipment on which is loaded the battery pack 1.

On a mounting surface 20, there is mounted one or more of a variety of circuit components 21, such as capacitor or IC. On one long side of the mounting surface 20 is mounted a connector terminal 22 for external connection, which connector terminal is electrically connected to a contact of the electronic equipment on which is loaded the battery pack 1. On the surface of the substrate 19 opposite to the mounting surface 20, there is formed a connection terminal, not shown, to which are connected the cathode terminal 12 and the anode terminal 13 of the polymer battery 2. The circuit components 21 and the connector terminal 22, formed on the mounting surface 20, are electrically connected to the connection terminal by a pattern wiring, not shown, formed on the substrate.

The battery case 4, formed by a plastics case, is made up by an upper case 4a and a lower case 4b, both of which are formed to substantially flat box shape, as shown in FIG. 2. The upper case 4a and the lower case 4b are abutted together to define an inner housing space within which are accommodated the polymer battery 2 and the circuit substrate 3.

At a mid portion of a longitudinal end of the lower case 4b, there is formed a terminal opening 23 which is provided for causing the connector terminal 22 of the circuit substrate 3 to face outwards. At the longitudinal end of the lower case 4b, there is provided a bonding portion 24, side-by-side with respect to the terminal opening 23, for bonding the identifier label 5, as later explained, and for causing this identifier label 5 to face outwards. This bonding portion 24 is a recess formed co-extensive as the identifier label 5 bonded to an end face 4c of an end part of the lower case 4b.

The identifier label 5, used for identifying the polymer battery 2 or the battery pack 1, is formed as a tag provided to the exterior material 7, or to the outer surface of the battery case 4 of the battery pack 1, for example, to the end face 4c of the end part of the lower case 4b. The identifier label 5 is made up by a base member 25, a light emitting layer 26 formed thereon, and a protective layer 27, as shown for example in FIG. 4.

The base member 25 is a single-layer or multi-layer member of plastics, such as polyvinyl chloride, nylon or polyethylene terephthalate, metals, such as copper or aluminum, paper sheets or other suitable material. The material type of the base member 25 is suitably selected in meeting with application and in consideration of the physical properties of the particular materials to be used.

The light emitting layer 26 is a color developing material, containing a light emitting material emitting the light on irradiation with invisible light, and an adhesive used for bonding the light emitting material and the base material 25 together according to an embodiment.

The light emitting material is colorless against the visible light and, when irradiated with invisible light, emits visible light and develops color. Specifically, the invisible light used is ultraviolet light, with a wavelength range of 300 nm to 450 nm, emitted by black light which emits invisible light, taken out from light of a peculiar wavelength, generated by a mercury lamp, by a specially designed ultraviolet filter. The color developing material emits fluorescent light, on irradiation with the ultraviolet light from the black light, to develop color, and can be enumerated by an organic phosphor material and an inorganic phosphor material. Of the organic and inorganic phosphor materials, there is a colorless phosphor material scarcely absorbing visible light or not at all absorbing visible light. The colorless inorganic phosphor material is superior in heat proofness, moisture proofness and durability.

The colorless inorganic phosphor material used is a pigment obtained on sintering crystals of oxides, such as Ca, Ba, Mg, Zn and Cd, sulfides, silicates, phosphates or tungstenates, as main component, added by metal elements, such as Mg, Ag, Cu, Sb or Pb, or rare earth elements, such as lanthanoids. The pigments preferred are those emitting red light, with the light emitting wavelength of 620 nm to 630 nm, green light, with the light emitting wavelength of 530 nm to 540 nm, and blue light, with the light emitting wavelength of 445 nm to 455 nm.

Examples of the inorganic phosphor material in an embodiment, emitting the red light, include Y₂O₃:Eu, YVO₄:Eu, (Y,Gd)BO₃:Eu, Y₂O₂S:Eu, 3.5MgO, 0.5MgF₂GeO₂:Mn and Y(P,V)O₄:Eu and the like. The inorganic phosphor material, emitting the red light, is used as particles having a mean particle size on the order of about 8.0 μm to about 9.0 μm.

Examples of the inorganic phosphor material in an embodiment, emitting the green light, include ZnO:Z, Zn₃SiO₂:Mn, Zn₃S:Cu,Al, (Zn,Cd)S:Cu,Al, ZnS:Cu,Au,Al, Zn₂SiO₄:Mn, ZnS:Ag,Cu, (Zn,Cd)S:Cu, ZnS:Cu, Gd₂O₂S:Tb, La₂O₂S:Tb, Y₂SiO₅:Ce,Tb, Zn₂GeO₄:Mn, ZnS:Cu,Co and the like. The inorganic phosphor material, emitting the green light, is used as particles having a mean particle size on the order of about 3.0 μm to about 3.5 μm.

Examples of the inorganic phosphor in an embodiment, emitting the blue light, include ZnS:Ag, CaWO₄, Y₂SiO₅:Ce, ZnS:Ag,Ga,Cl, Ca₂B₅O₃Cl:Eu²⁺, BaMgAl₁₄O₂₃:Eu²⁺, Sr₃(PO₂)₃Cl:Eu and the like. The inorganic phosphor, emitting the blue light, is used as particles having a mean particle size on the order of about 8.0 μm to about 9.0 μm.

By employing the aforementioned pigments, in addition to the inorganic phosphor materials, displaying the red, green and the blue light, as the light emitting material, it is possible to obtain desired colors, such as yellow, Mars yellow, pink or purple, or mixed colors thereof. The light emitting material can be surface-treated for improving the properties of the light emitting material, such as durability. The methods for surface treatment can be exemplified by coating fatty acids or by subjecting silane compounds to a coupling reaction.

Preferably, the adhesive has no band of absorption in a wavelength band of the ultraviolet light exciting the light emitting material, or in a wavelength band of visible light. The main components of the adhesive that can be used include thermoplastic resins, such as polyethylene based resins, such as polyethylene (PE), an ethylene-vinyl acetate copolymer (EVA) or a vinyl chloride-vinyl acetate copolymer, polypropylene (PP), vinyl based resins, such as polyvinyl chloride (PVC), polyvinyl butyral (PVB), polyvinyl alcohol (PVA), polyvinylidene chloride (PVdC), polyvinyl acetate (PVAc) or polyvinyl formal (PVF), polystyrene based resins, such as polystyrene (PS), a styrene-acrylonitrile copolymer (AS), or an acrylonitrile-butadiene-styrene copolymer (ABS), acrylic resins, such as polymethyl methacrylate (PMMA) or MMA-styrene copolymer, polycarbonate (PC), cellulose based resins, such as ethyl cellulose (EC), cellulose acetate (CA), propyl cellulose (CP), cellulose acetate butyrate (CAB) or cellulose nitrate (CN), fluorine based resins, such as polychlorofluoroethylene (PCTFE), polytetrafluoroethylene (PTFE), tetrasfluoroethylene-hexafluoroethylene copolymers (FEP) or polyvinylidene fluoride (PVdF), urethane based resins (PU), nylon based resins (type 6, type 66, type 610 or type 11), polyester (alkyd) based resins, such as polyethylene terephthalate (PET), polybutylene terephthalate (PBT) or polycyclohexane terephthalate (PCT), or novolak based phenol resins, as the main components. It is also possible to use thermosetting resins, such as resol type phenol resins, urea resins, melamine resins, polyurethane resins, epoxy or unsaturated polyester, or natural resins, such as protein, rubber, shellac, copal, starch or rosin, as the main components.

The adhesive can be added by a plasticizer for stabilizing the intensity of the light emitting layer 26, or a solvent, such as alkylbenzene, for adjusting the viscosity or the drying performance, in addition to the aforementioned main components, as necessary. An assistive agent for improving the viscosity, drying performance or dispersion performance of the light emitting layer 26 can also be added, if so desired. The assistive agent can be exemplified by, for example, a compound for improving the abrasion resistance of the as-dried light emitting layer 26.

The protective layer 27 is provided on the light emitting layer 26 and hence desirably exhibits high transmission performance with respect to the ultraviolet light illuminated on the light emitting layer 26 and to the visible light of the light emitted from the light emitting layer 26. The protective layer 27, having such properties, includes a transparent film layer formed of, for example, polyethylene terephthalate, polyvinyl chloride, polyethylene and polypropylene.

The light emitting layer 26 of the identifier label 5 is formed by applying a light emitting ink on the base member 25 by any of the well-known methods, including screen printing, relief printing, or intaglio printing, such as gravure printing. In particular, the screen printing, employing a screen plate with about 100 mesh to about 200 mesh, is most appropriate. On the identifier label 5, any of the aforementioned printing method is applied to develop a printing pattern so that the light emitting layer 26 represents, for example, a lot number or a bar code. The film thickness of the light emitting layer 26 is appropriately determined based on the luminosity of the fluorescent light or the content of the light emitting material as needed. A transparent film, operating as the protective layer 27, is laminated on the so formed light emitting layer 26 to complete the identifier label 5.

The method for assembling the battery pack 1, described above, is hereinafter explained. On the bonding portion 24, formed in the lower case 4b of the battery case 4, the identifier label 5, formed to a preset size, is bonded so that the surface of the light emitting layer 26 is exposed to outside. By providing the identifier label 5 in the end face 4c of the end part of the lower case 4b provided with the connector terminal 22, the end face 4c faces the lateral surface of the loading section of the electronic equipment, when the battery pack 1 is inserted in the loading section of the electronic equipment, so that the identifier label 5 can be protected by the lateral surface of the loading section.

The cathode terminal 12 and the anode terminal 13, extending from one end of the polymer battery 2, are welded and thereby connected to the connection terminals of the circuit substrate 3. The circuit substrate 3 is then arranged on the bonding surface 7a of the exterior material 7 so that the connector terminal 22 faces outwards.

The connector terminal 22, provided with the circuit substrate 3, is introduced into the terminal opening 23, formed in the lower case 4b. The polymer battery 2 and the circuit substrate 3, connected to the polymer battery 2, are assembled to the lower case 4b, and the upper case 4a is fitted to the lower case 4b, to complete the battery pack 1, shown in FIG. 1, in which the connector terminal 22 of the circuit substrate 3 is exposed from the terminal opening 23 of the lower case 4b.

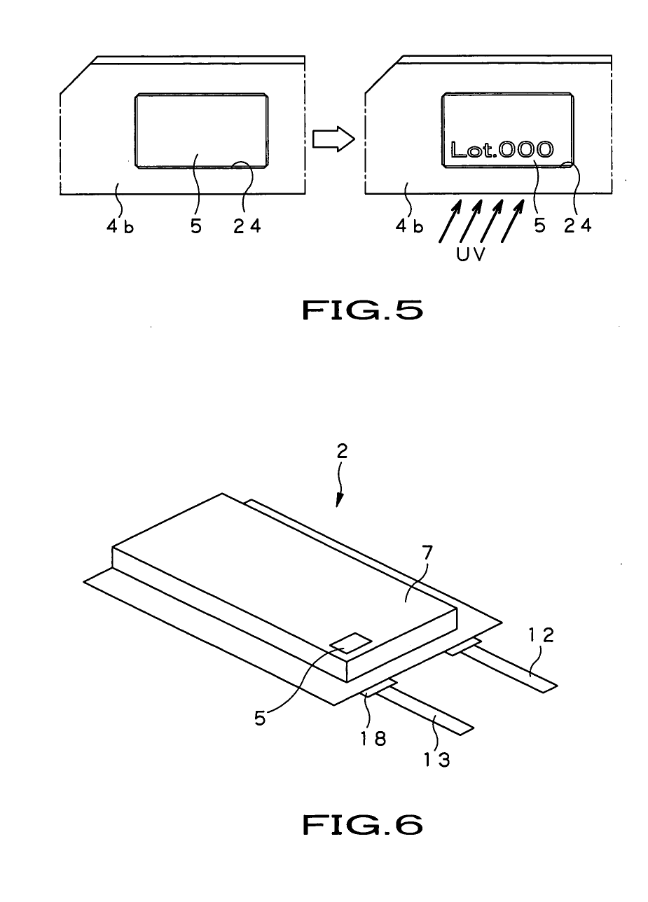

The method for identifying the battery pack 1, prepared as described above, is now explained. The identifier label 5, exposed from the bonding portion 24 of the battery case 4, is in a colorless (white) state under the visible light, such as solar light or light of routine illumination. Using a black light, emitting the ultraviolet light, having the wavelength of, for example, about 300 nm to about 450 nm, the ultraviolet light is illuminated on the identifier label 5 in this colorless state, as shown in FIG. 5. When illuminated with the ultraviolet light, the light emitting material of the identifier label 5 is excited with the ultraviolet light to emit light to develop the color of the selected light emitting material. Hence, the portion of the light emitting layer having a patterned lot identification number emits light to a specified color, from the colorless state, as shown in FIG. 5. In this regard, the lot number is demonstrated in relief. As the black light, a phosphor tube, an electrical bulb, a light condenser/projector or a light emitting diode of a shorter wavelength, for example, can be used. As the illuminating light, a germicidal lamp, capable of emitting the ultraviolet light with a wavelength of about 250 nm, can be used as the illuminating light for exciting the light emitting material, in addition to the black light.

Thus, with the battery pack 1 which, when illuminated with the ultraviolet light, emits the visible light selected by the producer to develop the color, it is possible to verify readily the authenticity of the battery pack 1. With the present battery pack 1, in which a colorless inorganic phosphor material is used for forming the identifier label 5, the presence of the identifier label 5 is not noticed under the visible light, such as common illuminating light, by a third party. In case a falsified product of the battery pack is produced by a third party, it is possible for the authentic producer to verify the difference between the battery pack 1 and the falsified product by illuminating the invisible light to the battery pack and the falsified product.

Moreover, with the present battery pack 1, in which the pigment is mixed along with the phosphor material, the identifier label is colorless to the visible light, but develops the color peculiar to the producer, so that counterfeiting of the identifier label 5 becomes difficult. Hence, with the present battery pack 1, the difference from the counterfeited product can become explicit, while it becomes difficult to produce a counterfeit.

Additionally, with the present battery pack 1, in which the identification information, such as lot number, is patterned as the light emitting layer, it is possible to verify the authenticity of the battery pack 1 as well as to specify the producing apparatus and/or the producer.

Instead of being provided on the battery pack 1, the identifier label 5 can also be bonded to the exterior material 7 of the polymer battery 2, such as with an adhesive, as shown in FIG. 6, in order to verify the authenticity of or identify the polymer battery 2.

The identifier for the battery is not limited to the tag-type identifier label 5 and can be directly coated on the outer surface of the battery case 4 of the battery pack 1 or to the outer surface of the exterior material 7 of the polymer battery 2 to form the lot number or the identification number. In case the light emitting ink is directly applied to the exterior material 7, it is unnecessary to provide the base member 25, thus assuring cost reduction.

The battery to be provided with the battery identifier is not limited to the polymer battery 2 but can also be a dry battery, such as a manganese dry battery. There is also no limitation to the type of the battery pack 1.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. A battery identifier provided on a battery or a battery pack thereof, the battery identifier comprising a light emitting material that is colorless against a visible light wherein the light emitting material is capable of emitting the visible light when illuminated by an invisible light.

2. The battery identifier according to claim 1, wherein the invisible light includes an ultraviolet light.

3. The battery identifier according to claim 1, wherein the light emitting material includes an inorganic phosphor material.

4. A battery comprising:
a battery element having a cathode and an anode;
an exterior material for accommodating the battery element therein; and
a battery identifier provided on an outer surface of the exterior material,
the battery identifier including a light emitting material that is colorless against a visible light wherein the light emitting material is capable of emitting the visible light when illuminated by an invisible light.

5. The battery according to claim 4, wherein the invisible light illuminated on the battery identifier includes an ultraviolet light.

6. The battery according to claim 4, wherein the light emitting material includes an inorganic phosphor material.

7. A battery pack comprising:
a battery provided with a cathode and an anode, wherein the battery operates as a power generating element;
a battery case for accommodating the battery therein; and
a battery identifier provided on an outer surface of the battery case,
the battery identifier containing a light emitting material that is colorless against a visible light wherein the light emitting material is capable of emitting the visible light when illuminated by an invisible light.

8. The battery pack according to claim 7, wherein the invisible light includes an ultraviolet light.

9. The battery pack according to claim 7, wherein the light emitting material includes an inorganic phosphor material.
